(19) United States
(12) Patent Application Publication
(10) Pub. No.: US 2007/0140660 A1
(43) Pub. Date: Jun. 21, 2007

(54) Description data structure for displaying a menu in an audio/video disc and method for using the same

(76) Inventors: Wei-Zheng Lu, Chiayi City (TW); Meng-Han Tsai, Taipei City (TW); Guo-Zua Wu, Taichung (TW); Kun-Da Wu, Nantou City (TW); Der-Ray Huang, Hsinchu City (TW); Jau-Jiu Ju, Hsinchu Hsien (TW)

Correspondence Address: J.C. Patents, Inc., Suite 250, 4 Venture, Irvine, CA, 92618, US

(21) Appl. No.: 11/399,826

(22) Filed: Apr. 7, 2006

(30) Foreign Application Priority Data
Dec. 15, 2005 (TW) 94144419

(51) Int. Cl. H04N 7/00

(52) U.S. Cl. 386/96

(57) ABSTRACT

A description data structure of a menu stored in an audio/video disc and a method for using the same are provided. The description data structure comprises a navigation data packet, a menu packet, and a program packet, wherein the menu packet further comprises a first header, a background image packet, a button 1 packet, a button 2 packet, etc. Moreover, each button packet comprises sub-picture information, and the navigation data packet comprises a button address packet for storing the address information of each button packet. By using the description data structure, the present invention allows not only the audio/video disc to be consumed less capacity for displaying images, but the use of a mask control program stored in the audio/video disc to be cancelled as well when highlighting a selected text in the menu, thereby expediting the processing of the stored data in the audio/video disc.

### CROSS-REFERENCE TO RELATED APPLICATION

This application claims the priority benefit of Taiwan application serial no. 94144419, filed on Dec. 15, 2005. All disclosure of the Taiwan application is incorporated herein by reference.

### BACKGROUND OF THE INVENTION

1. Field of Invention

The present invention relates to a description data structure stored in an optical disc, and more particularly, to a description data structure of a menu stored in an audio/video disc and a method for using the same.

2. Description of Related Art

In various storage medium, optical discs have been widely used in various fields due to their advantages of high capacity, low cost, easily carrying, and so on. They are applied for storing data including music songs and films. To be adapted for the characteristic of the optical disc and enhance the reliability of reading the optical disc, when storing data in the pre-recorded optical disc, if the encoded data is 1, the recording surface of the optical disc coated with an organic dye is directly heated by a laser beam (775 nm-795 nm) output from a high power semiconductor laser, thereby burning the recording surface to form a data pit, whereas, if the encoded data is 0, no data pit is formed.

When the optical disc is read by a disc player with a low power laser beam, the burnt data pit absorbs a part of the laser beam, whereas the un-burnt recording surface does not absorb but reflects the laser beam because the data pit and the un-burnt recording surface have different reflection indexes. Thus, the disc player converts the different reflection results into their original encoded digital data, i.e., a sequence of information consisting of 0 and 1.

When a user plays the optical disc with the disc player, such as when watching films or singing with a karaoke, a menu is provided on a screen for highlighting an option selected by the user through a moving on the menu by manipulating a remote controller, and then the user presses a button on the remote controller to enter this option. The conventional ways of highlighting the menu will be illustrated below with reference to FIGS. 1A, 1B, and 2.

First, referring to FIG. 1A, it shows a bottom frame (i.e., a display screen) 1 with the menu. The bottom frame 1 comprises a background image displayed by pixel information stored in a background packet, such as clouds 2 of the blue sky and background colors, as well as characters A, B, C, D, E, and F displayed by the pixel information stored in multiple title packets, wherein A, B, and C constitute a first set option, whereas D, E, and F constitute a second set option, and the first and second set options are respectively used to execute specific functions, such as the selection of Chinese or English speech, etc. However, in practice, each of multiple title packets stores pixel information of a variety of texts, such as “1.Mandarin speech,” or “2.English speech,” as options to be selected according to the user's favor.

Then, referring to FIG. 1B, it is a combined diagram showing the menu with a highlighted option, wherein, from left to right, there respectively shows a background image, a character image, a highlight-selecting information diagram 1′ including a position information frame H′ for selecting a text to be highlighted, and a resultant diagram. It is apparently shown in FIG. 1B that the resultant diagram is formed by overlapping the background image displayed by the pixel information of the background packet and the title image of A, B, C, D, E, and F displayed by the pixel information of the multiple title packets. At this time, depending on the user's selection on the menu, if the first set option is selected, the position information frame H′ moves upwards as indicated by an arrow X, such that A, B, and C are highlighted as a first highlighted frame 4; otherwise, if the second set option is selected, the position information frame H′ moves downwards as indicated by an arrow Y, such that D, E, and F are highlighted as a second highlighted frame 5.

FIG. 2 is a alternative diagram illustrating operations of the highlight-selecting information diagram 1′ of FIG. 1B, wherein the bottom layer comprises a bottom frame 1 including background clouds 2 and a title 3; the middle layer and the top layer are a highlight layer and a mask layer, respectively. Moreover, the highlight layer is substantial a virtual layer of the highlight-selecting information diagram 1′, correspondingly overlapped with the bottom frame 1 and formed by one program of playing control programs, and pixels in the highlight frame 4, 5 are highlighted with a specific color (such as, dark blue). The positions of the highlight frames 4, 5 are correspondingly overlapped with the positions of the title ABC and DEF in the bottom layer. In the mask layer, a virtualized window 4′ of the highlight-selecting information diagram 1′ is generated through the mask control program for selecting the highlight frame, and the virtualized window 4′ is used for selectively displaying the highlight frame 4 or highlight frame 5 on the screen, such that the options of the menu is arbitrarily highlighted.

The conventional ways for highlighting the menu have some drawbacks. For example, the bottom frame layer and the highlight-selecting information diagram 1′ are required to generate the mask layer, such that the data processing becomes more complicated. Besides, when the user has selected the option on the menu and pressed the bottom, the menu disappears from the screen and forces the audio/video file to be displayed automatically.

On the other hand, the description data structure P stored in the menu of the optical disc is shown in FIG. 3, wherein a, b, and c indicate the data structure stored in the audio/video disc for composing sub-pictures. In other words, as for each sub-picture, the description structures a, b, and c of DVD shown on the screen is shown as a whole screen picture containing a single character A. Furthermore, a, b, and c indicate three regions, i.e. navigation data packet, background packet (menu A/V data), and Title A/V data packet, respectively, wherein the navigation data packet enables the player how to play images and sound stored in the subsequent menu and title packets. In addition, many navigation packs are located in the Menu A/V Data and the Title A/V Data in the conventional art (DVD) and the data of the navigation data and the navigation pack are required for navigating the selected one packet of the Menu and Title Data when displaying the menu. The background packet b comprises a navigation packet header b′ and background pixel information b″. Also, the Title A/V Data herein is a multiple title packets c consisting of character packets, each of which comprises a navigation packet header c′ and the pixel information c″ of a single character. FIG. 3 shows a data structure of a single sub-picture, however, the menu for watching the audio/video programs includes multiple sub-pictures. Thus, the conventional menu to be displayed consumes significant capacities of the audio/video disc for storing the aforementioned multiple sub-picture data. The position information of text to be highlighted is stored in the navigation data a. When a certain option on the menu is to be highlighted, the background packet b and a navigation packet header c′ of each single character packet of the multiple title packets c are searched one by one by the navigation data, and the text to be highlighted is displayed according to the stored position information in the navigation data. As such, highlighting the menu requires a tedious procedure.

Therefore, to solve the above problems of the conventional art, a method for simplifying the information processing, that is, a description data structure of the menu stored in the optical disc and a method for using the same are desirable, which simplify the procedures for highlighting the menu, and maintain the effects of the menu while only displaying a sound file.

### SUMMARY OF THE INVENTION

The present invention provides a description data structure of a menu stored in an optical disc and a method for using the same, wherein the description data structure comprises a navigation data packet, a background packet, and multiple title packets. The address information of the multiple title packets is stored in the navigation data packet. Each of the title packets comprises the pixel information of the highlighted text, and a header including the screen displaying position information of the highlighted text. With the description data structure, the disc player displays the background packet and the pixel information in the title packet selected by the user on the screen without using a mask control program for selecting the highlighted text.

Another object of the present invention is to provide a description data structure of a menu stored in the optical disc and a method for using the same, wherein when the navigation data packet, the background packet, and the multiple title packets are read from the optical disc by the user, a playing program determines whether the selected one by the user from the menu is a sound file or not. If yes, the picture of the original menu is retained and the sound file is played; if no, the picture of the original menu is eliminated and the audio/audio/video file is then played. Therefore, if the user selects the sound file by mistake, the picture of the original menu is still retained, therefore it is more convenient for the user without having to press the button MENU on the remote controller again.

To the make the aforementioned and other objects, features and advantages of the present invention comprehensible, a preferred embodiment accompanied with figures is described in detail below.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is a conventional screen with a menu.

FIG. 1B is a combined diagram of the menu with highlighted options.

FIG. 2 is a diagram for further illustrating operations of the highlight-selected information diagram 1′ of FIG. 1B.

FIG. 3 is a conventional description data structure of a menu stored in an audio/video disc.

FIG. 4 is a description data structure of an menu stored in the audio/video disc according to a preferred embodiment of the present invention.

FIG. 5 is a flow chart for retaining the picture of the menu when the user selects a sound file from the menu by mistake.

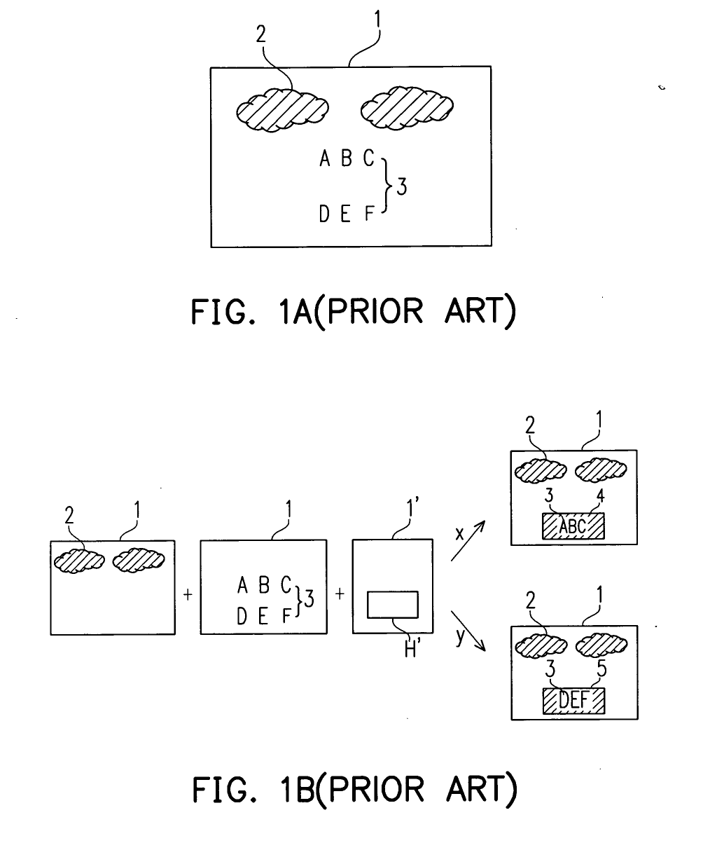

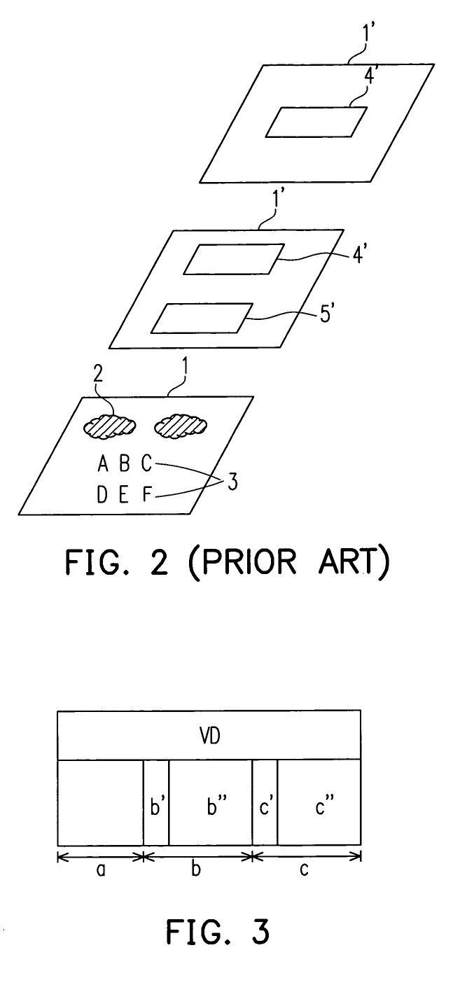

### DESCRIPTION OF EMBODIMENTS

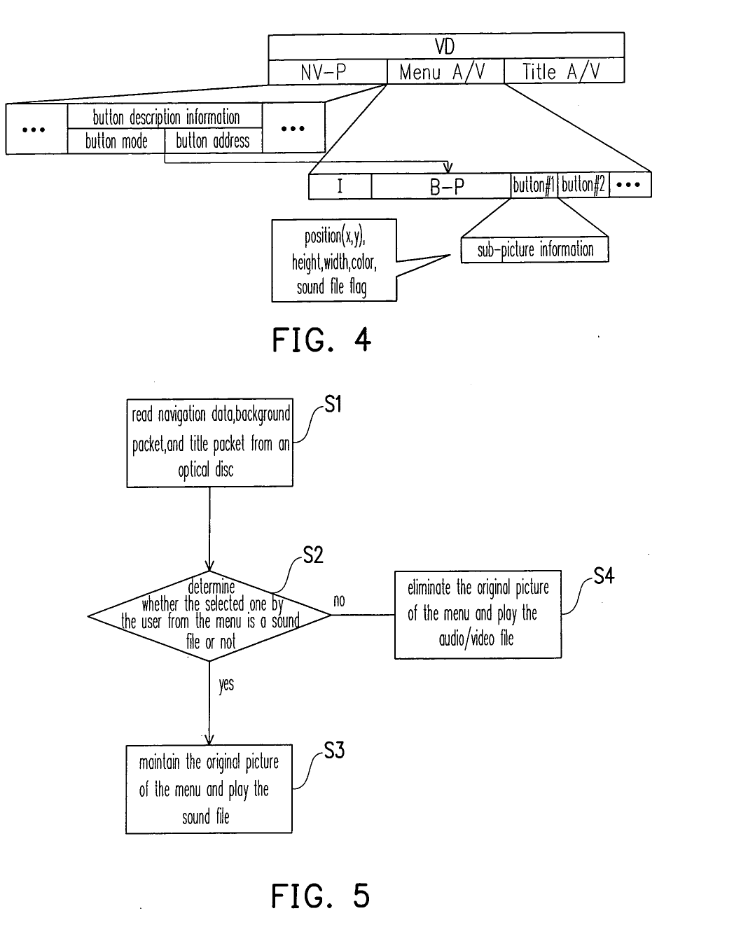

Referring to FIG. 4, it is a description data structure of a menu stored in an audio/video disc according to a preferred embodiment of the present invention. The description data structure comprises a navigation data packet NV-P, a menu packet (i.e. a menu Audio/Audio/video), and a title packet (title A/V), e.g., film programs of a film disc. The difference between the description data structure of the menu in the present invention and the conventional one of FIG. 3 is that there is no navigation pack in the audio/video packet and the title packet of the present invention, and the required navigation data are all collectively located in the navigation data packet. There are only images, sounds, sub-pictures (or referred as titles) data in the audio/video packet and the title packet. In addition, as for the application of the recorder authoring, after a certain audio/video segment is recorded on a disc, once another audio/video segment is subsequently recorded therein, it must be connected with the previous segment, and so does the menu. According to the preferred embodiment of the present invention, it can be achieved only through regenerating data in the navigation data region. If this situation happens to the conventional art, the navigation data in the audio/video packet must be regenerated again and then combined with the audio/video stream to be written into the audio/video packet region, which is more complicated and time-consuming than the method of the present invention. Referring to FIG. 4, the navigation data packet NV-P of the present invention comprises button-description information. The button-description information further includes button modes and button addresses comprising the addresses of a button 1 packet, a button 2 packet, and so on, wherein these button packets are located following the navigation data packet, and in the button modes, a button mode 1 indicates a normal playing, a button mode 2 indicates a previewing and a button mode 3 indicates playing the sound file only.

Moreover, the menu packet comprises a first header having a attribute of the menu packet stored therein, a background pixel information packet B-P, the button 1 packet, the button 2 packet, and the like, wherein each button packet substantially indicates one option of a menu, i.e. a sub-picture or a single title image. Therefore, each button packet includes a second header and pixel information of a highlighted text, and the second header includes the information of the displaying position on the screen, height, width, color, sound file flag, and the like.

Thus, when the audio/video disc is played by the player, an menu is displayed on the screen, and as the menu is moved by the user, the playing control program of the disc player drives the navigation data packet NV-P to read the corresponding button packet according to the address information of the button address packet therein, such that the highlighted text or image is movably displayed on the screen by the pixel information of the highlighted text of each button packet according to the screen displaying position stored in the button packet. Compared with the conventional art, the header b′ of the background packet b and the navigation data packet header c′ of each of the multiple single title packet c are sequentially searched one by one by the navigation data, such that the highlighted text is displayed according to the position information of the highlighted text stored therein.

Thus, obviously, with the description data structure of the menu stored in the optical disc according to the preferred embodiment of the present invention, the playing control program searches the address information of the corresponding single title packet in the navigation data packet NVP, so as to display the highlighted text on the screen according to the screen displaying position information within the header, thereby greatly simplifying the procedures required by highlighting the menu.

The picture of the menu doesn't disappear when the user selects the sound file from the menu by mistake, and the control flow chart is illustrated as follows. Referring to FIG. 5, first, the navigation data packet NV-P, the background packet, and the title packet are read from the optical disc by the user in step S1. Then, the playing program determines whether the selected one by the user from the menu is a sound file or not, as shown in step S2. If yes, the original picture of the menu is retained and the sound file is played in step S3; if no, the original picture of the menu is eliminated and the audio/audio/video file is played, as shown in step S4. Therefore, if the user selects the sound file by mistake, the original picture of the menu is still retained, such that it is more convenient for the user without having to press the MENU button on the remote controller again.

In summary, the description data structure of the menu stored in the optical disc and the method for using the same have the following advantages:

1. In the conventional art, since the description structure a, b, and c of the audio/audio/video disc of each sub-picture is shown as a whole diagram with a single character A on the screen, when multiple highlighted text are to be shown conventionally, significant capacities of the audio/video disc will be consumed for storing the data of the above multiple sub-pictures. In contrast, the sub-picture of the present invention is an object (i.e. the sub-picture doesn't contain data of the background screen), Such that the capacity of the audio/audio/video disc is effectively used and the information processing is thereby simplified.

2. The address information of the background packet and the multiple title packets for the description data structure are stored within the navigation data, and each of the multiple title packets includes a highlighted text and information of its display position on the screen. Through the description data structure, the disc player displays the pixel information in the background packet and the title packet on the screen without using the mask control program for selecting the highlighted text.

3. Through the description data structure of the menu stored in the optical disc of the present invention, the address information of the corresponding single title packet in the navigation data packet NV-P is searched by the playing control program, and the highlighted text is displayed on the screen according to its display position information stored in the header, thus the procedures required for highlighting the menu are greatly reduced.

4. The present invention provides the function of maintaining the original picture of the menu when the user selects the sound file from the menu by mistake.

5. As for the application of the recordable audio/video disc, when the menu is to be re-edited on the optical disc with the menu, only the NV-P is required to be re-edited in the present invention, without regenerating the title packet again.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A description data structure of a menu stored in an audio/video disc, comprising:
a navigation data packet, comprising a button description information, and the button description information further comprises button modes and button addresses comprising the addresses of a button 1 packet, a button 2 packet, and so on, wherein these button packets are located following the navigation data packet;
a menu packet, comprising a first header, a background pixel information and information of the button 1 packet, the button 2 packet, and so on, wherein each information of these button packets is used for displaying a highlighted text on a screen, each of these button packets comprises a second header and pixel information of the highlighted text, the second header further comprises screen displaying position information of the highlighted text and the navigation data packet comprises the address information of each single title packet.

2. The description data structure as claimed in claim 1, wherein the first header further comprises displaying position information of the background pixel information on the screen.

3. The description data structure as claimed in claim 1, wherein the navigation data packet is stored in a separated file.

4. The description data structure as claimed in claim 1, wherein the description data structure allows a disc player not to use a mask control program for selecting the highlighted text.

5. A method for selecting an option of a menu from an audio/video disc, comprising:
reading a navigation data packet, a background packet comprising a first header and background pixel information, and multiple button packets form the optical disc, wherein each multiple button packet comprises a second header and pixel information of a highlighted text, so as to display the menu on a screen, and the navigation data packet comprises a button-description information, and the button-description information further comprises button modes and button addresses corresponding to the multiple button packets;
searching the address information of a selected title packet stored in the navigation data packet by a playing control program according to a user's favor; and
displaying a highlighted text on the screen, according to the screen displaying position information of the highlighted text in the second header of the selected single title packet.

6. The method for selecting an option of a menu from an audio/video disc as claimed in claim 5, wherein the method allows a disc player not to use a mask control program for selecting the highlighted text.

7. The method for selecting an option of a menu from an audio/video disc as claimed in claim 5, wherein the navigation data packet further comprises the address information of the background packet, such that the text pixel information of the title packet and the background pixel information of the background packet are alternatively displayed on the screen.

8. The method for selecting an option of a menu from an audio/video disc as claimed in claim 5, wherein the picture of the menu is retained when the user selects a sound file from the menu by mistake.

9. The method for selecting an option of a menu from an optical disc as claimed in claim 8, wherein the control flow for retaining the menu comprises:
determining whether an option selected by the user from the menu is a sound file or not, wherein if yes, it further comprises maintaining the picture of the menu and playing the sound file; and
if no, it further comprises eliminating the picture of the menu and playing an audio/audio/video file.
